(19) United States
(12) Patent Application Publication
(10) Pub. No.: US 2017/0194906 A1
(43) Pub. Date: Jul. 6, 2017

(54) METHOD AND SYSTEM FOR DETERMINING TIME POINT TO CLEAN SOLAR CELL MODULE AND SOLAR CELL MODULE SYSTEM BY USING THE SAME

(71) Applicant: UKC Electronics (H.K.) Co., Ltd., Kowloon (HK)

(72) Inventors: Jin-Syung CHEN, Kowloon (HK); Pei-Chin LIN, Kowloon (HK); Hsien-Chang LIN, Kowloon (HK); Jui-Kang CHIANG, Kowloon (HK); Lai-Pheng GAN, Kowloon (HK); Chin-Yin LEE, Kowloon (HK); Hsiang-Tzu WU, Kowloon (HK)

(21) Appl. No.: 15/448,392

(22) Filed: Mar. 2, 2017

Related U.S. Application Data
(63) Continuation of application No. PCT/CN16/71007, filed on Jan. 15, 2016.

(30) Foreign Application Priority Data
Dec. 31, 2015 (TW) 104144597

(51) Int. Cl. H02S 50/00; G06F 1/26; G06F 17/11; H02S 40/10

(52) U.S. Cl. CPC H02S 50/00; H02S 40/10; G06F 1/26; G06F 17/11

(57) ABSTRACT

A system and method for determining a time point to clean a solar cell module are provided. The method may include the process of calculating a power generation loss of the solar cell module in a time period due to dust accumulation; converting calculated the power generation loss in the time period due to dust accumulation into a cost of the power generation loss; calculating a total cost of the power generation loss when it is equal to a cost of cleaning through the cost of the power generation loss in the time period; and determining the time point of cleaning by referring to the total cost of the power generation loss.

### PRIORITY CLAIMS/RELATED APPLICATIONS

This application is a continuation of PCT/CN2016/071007, filed 15 Jan. 2016 that claims priority to Taiwanese patent application Serial No. 104144597, filed 31 Dec. 2015, the entirety of which are incorporated herein by reference.

### FIELD

The disclosure relates to a system and method for determining the time point of cleaning a solar cell module and a solar cell module system using the same.

### BACKGROUND

Currently, fossil fuel is the main energy resource and is widely used in providing electricity to human in everyday life. However, as the energy resource of fossil fuel gradually depletes, the climate changes and the eco-system disorders due to the fossil fuel increase, countries are making efforts on development of alternative energies, such as solar energy, wind energy, geothermal energy and hydro-energy, of which power generation using solar energy attracts the most attention. The amount of solar energy reaching earth's surface for one hour can provide a whole year of energy to humans, and solar energy is an inexhaustible natural resource. Solar power generation has advantages such as that it is never exhausted and can be easily incorporated in a building. Further, as the rapid advancement of semiconductor material in recent years, the photoelectric conversion efficiency of solar energy continues to improve so that the solar cell modules have been widely utilized by consumer generally.

However, various environmental factors strongly affect the power generation efficiency of a solar cell module. For example, the climate, the season or whether it is day or night all affect the amount of power generated by the solar cell module. Additionally, dirt and/or dust are known to reduce the amount of solar power generation. Usually, in order to prevent the dirt or dust from reducing the amount of power generation, the solar cell module is cleaned to ensure the efficiency of power generation. However, although the continuous cleaning for the solar cell module can ensure that the solar cell module is clean, the cost of cleaning will increase and thus lacks economic benefits.

A solar cell module efficacy monitoring system and method exists that calculates the power generation loss of solar cell module and compares it with the rated output in order to calculate the power loss when actually operating the solar cell module. However, that system and method does not mention any effective strategy for dealing with the power loss due to dust accumulation, e.g. by replacing or cleaning.

In addition, a method for solar power generation monitoring and a solar power generation monitoring system are provided that monitors various power losses of solar power generation system and detects any abnormality. However, this system again does not mention any effective strategy for dealing with the power loss due to dust accumulation.'

In view of the above limitations of the systems, research and development were actively conducted in order to provide an effective method to avoid the power loss of solar cell module due to dust accumulation thereby reaping the economic benefits which is disclosed below.

### BRIEF DESCRIPTION OF THE DRAWINGS

FIG. 1 is a diagram illustrating a calculation method according to a first embodiment of for determining the time point to clean the solar cell module;

FIG. 2A is a flowchart showing a method according a first embodiment for determining the time point to clean the solar cell module;

FIG. 2B illustrates a system or apparatus according a first embodiment for determining the time point to clean the solar cell module;

FIG. 3 is a diagram illustrating the calculation method according to a second embodiment of the present invention for determining the time point to clean the solar cell module;

FIG. 4 is a flowchart showing the method according the second embodiment for determining the time point to clean the solar cell module;

FIG. 5 is a block diagram showing the solar cell module system according to the present invention using the method for determining the time point to clean the solar cell module; and

FIG. 6 is an example of the data for the method for determining the time point to clean a solar cell module.

### DETAILED DESCRIPTION OF ONE OR MORE EMBODIMENTS

The disclosure is particularly applicable to a system and method for determining a solar module cell cleaning and it is in this context that the disclosure will be described. It will be appreciated, however, that the system and method has greater utility, such as to use with a plurality of solar modules, a plurality of solar cells and the like. According to a first aspect of the disclosure, a method and system for determining a time point to clean a solar cell module are provided. The method may comprise: calculating a power generation loss of the solar cell module in a time period due to dust accumulation; converting the calculated power generation loss in the time period due to dust accumulation into a cost of the power generation loss; calculating a total cost of the power generation loss when it is equal to a cost of cleaning through the cost of the power generation loss in the time period; and determining the time point of cleaning by referring to the total cost of the power generation loss.

According to a second aspect of the disclosure, a method and system for determining a time point to clean a solar cell module are provided. The method may comprise: calculating an accumulative power generation loss of the solar cell module due to dust accumulation; converting the calculated accumulative power generation loss due to dust accumulation into a cost of the power generation loss; instantaneously comparing the cost of the power generation loss with a cost of cleaning so that, if the cost of the power generation loss is less than the cost of cleaning, the method will return to calculating the accumulative power generation loss of the solar cell module due to dust accumulation. If the cost of the power generation loss is equal to or greater than the cost of cleaning, then the method may generate a notification of cleaning when the cost of the power generation loss is equal to or greater than the cost of cleaning.

According to a third aspect of the disclosure, a solar cell module system is provided. The solar cell module system comprises: a reference module which is a solar power generation module and its surface is maintained in a clean condition; an evaluation module which is a solar power generation module and is covered by dust in a real environment; a data collecting element which is configured to collect the data relevant to the power generation loss of the evaluation module due to dust accumulation, calculate the power generation loss, and make a calculation of a time point of cleaning; and a display element which is configured to display the time point of cleaning calculated by the data collecting element; wherein the solar cell module system uses the method described above for determining the time point to clean the solar cell module to determine the time point of cleaning.

According to the method and system of the disclosure for determining the time point to clean the solar cell module and the solar cell module system using said method, the power loss of the solar cell module due to dust accumulation could be effectively avoided and thus the economic benefits may be reaped.

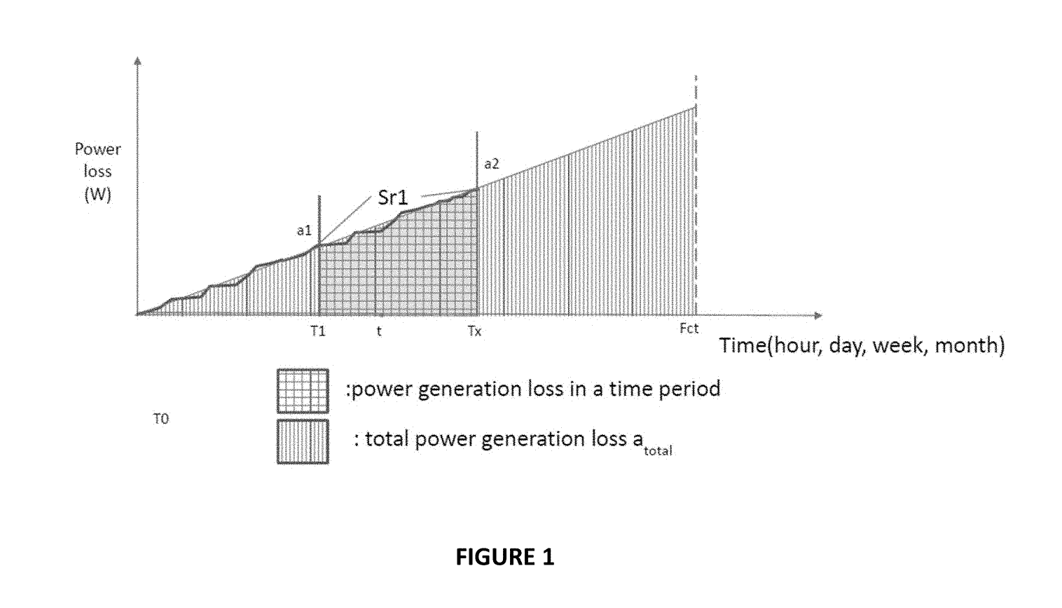

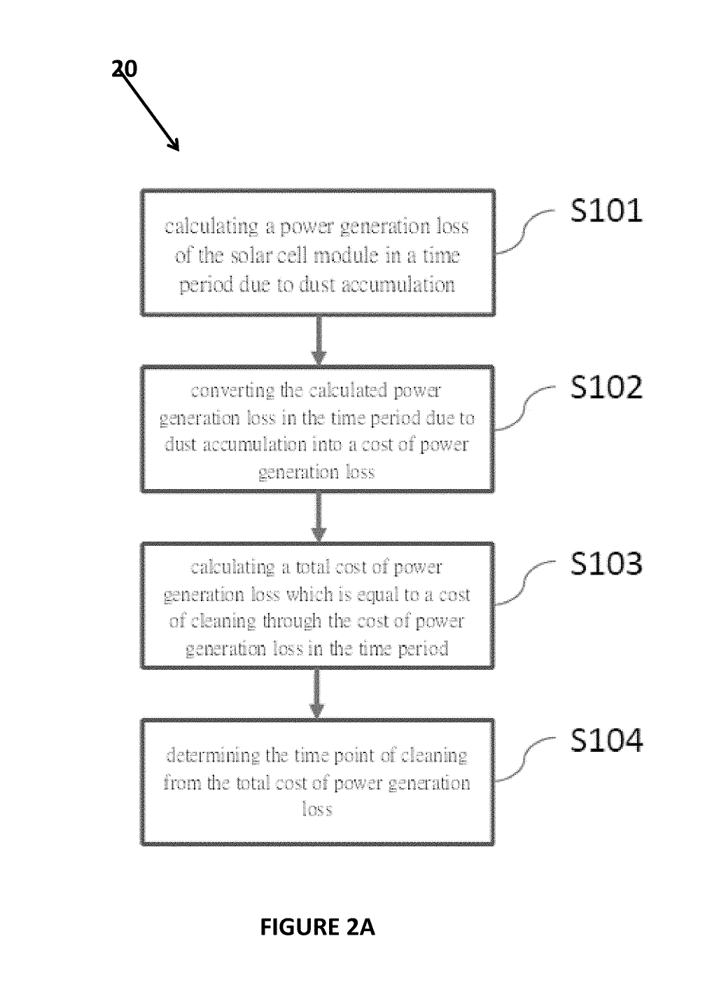

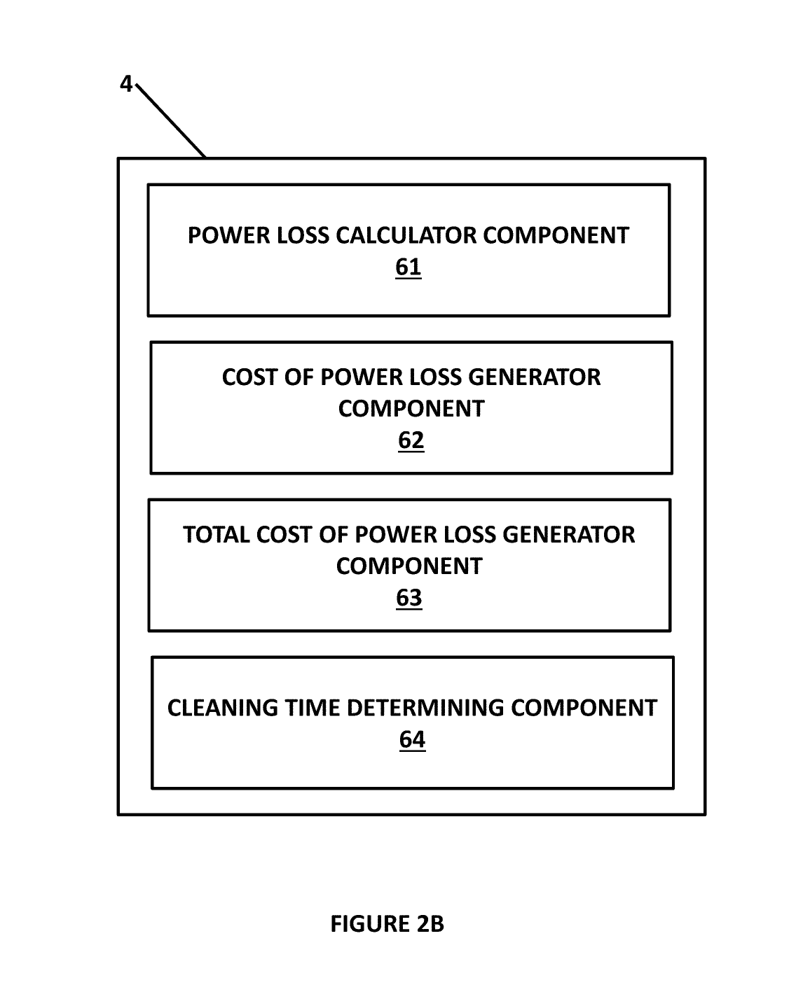

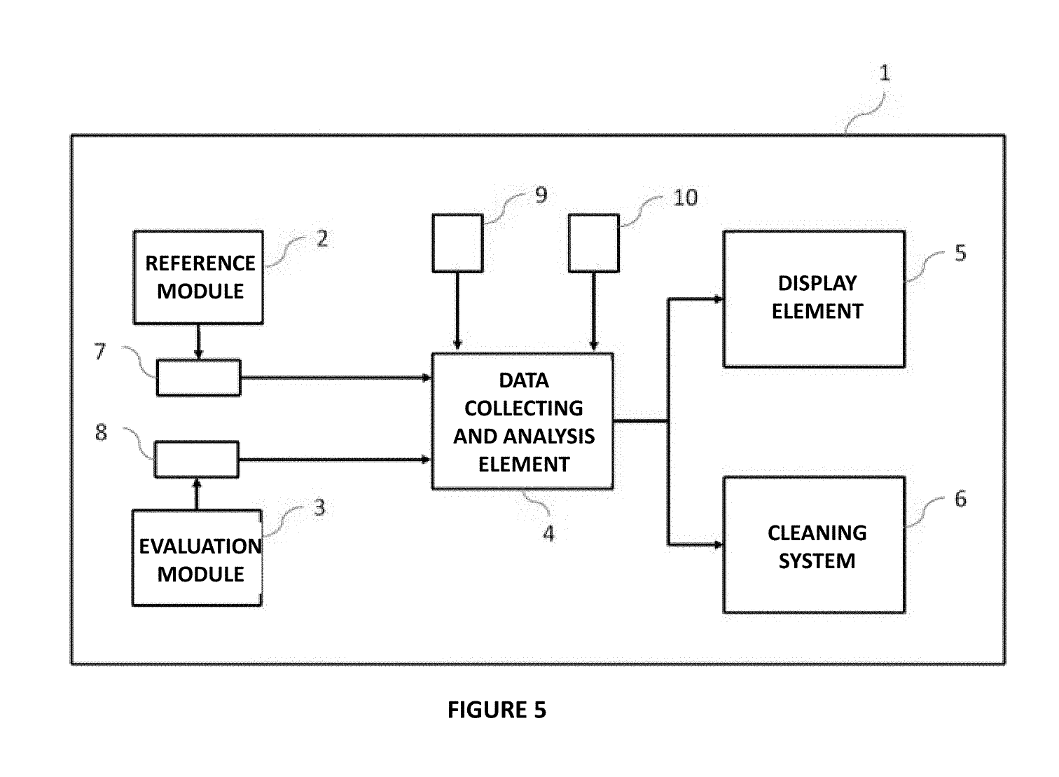

With reference to FIG. 1 and FIG. 2A, a method for determining the time point to clean a solar cell module according to the first embodiment of the disclosure will be described below. FIG. 1 is a diagram illustrating the calculation method according to the first embodiment of the present invention for determining the time point to clean the solar cell module. The horizontal axis of FIG. 1 represents time and the vertical axis of FIG. 1 represents power loss (in Watts). FIG. 2A is a flowchart showing the method according the first embodiment for determining the time point (Fct shown in FIG. 1) to clean the solar cell module and FIG. 2B illustrates a data collection and analysis system or apparatus 4 according a first embodiment for determining the time point to clean the solar cell module. FIG. 1 shows a power loss of a solar module over a time period (hours, days, weeks and/or months) wherein a total power generation loss, a_{TOTAL}, over time is shown by parts of graph with straight vertical lines and the power generation loss during a time period (T1 to Tx in the example in FIG. 1) is shown by the parts of the graph with a checkerboard pattern. Before describing the method with respect to FIG. 2A, a data collection and analysis system or apparatus 4 in FIG. 2B and a solar cell module system 1 in FIG. 5 that may incorporate the data collection and analysis system and apparatus 4 are described.

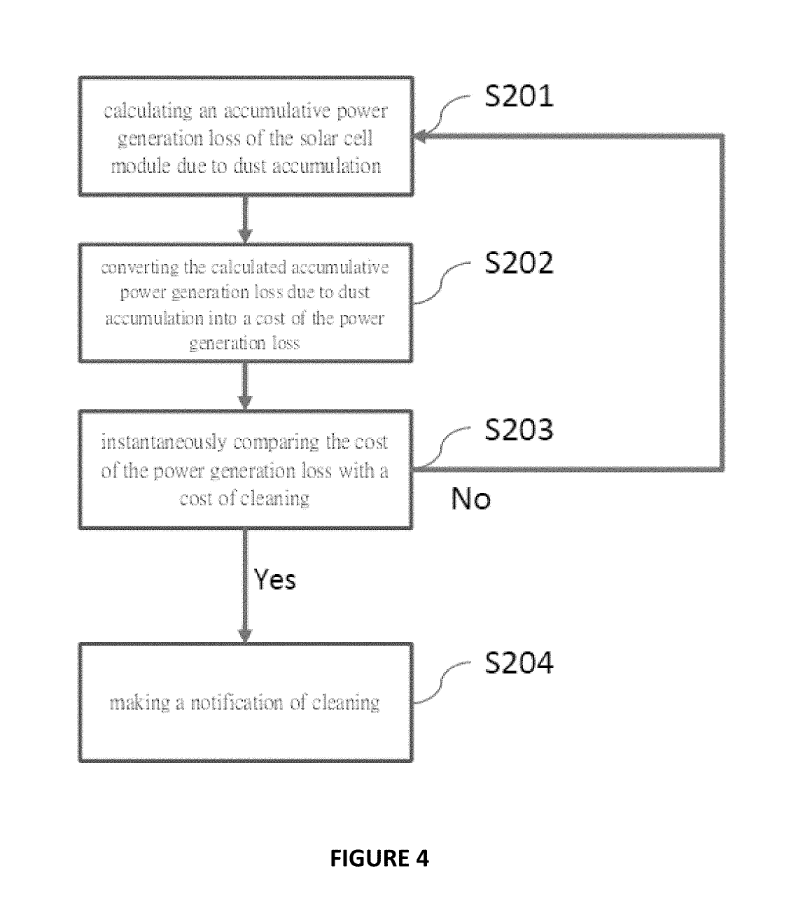

The data collection and analysis system/apparatus 4 shown in FIG. 2B may be implemented in software or hardware. Furthermore, each of the components 61-64 of the data collection and analysis system/apparatus 4 may also be implemented in hardware or software. In addition, certain of the components 61-64 may be implemented in hardware and certain of the components may be implemented in software. When the cleaning system/apparatus 6 or any component 61-64 is implemented in software, the component may comprise a plurality of lines of computer code (instructions) that may be executed by a processor of the data collection and analysis system/apparatus 4 so that the processor of the data collection and analysis system/apparatus 4 is configured to perform the processes shown in FIG. 2A or 4 of the method. In these software embodiments, the data collection and analysis apparatus/system 4 may be one or more computing resources, including at least one processor, that can store and execute the plurality of lines of computer code. For example, the data collection and analysis apparatus/system 4 may be a server computer, one or more blade servers and the like. When any of the components 61-64 is implemented in hardware, the component may be a hardware device, such as a microcontroller, a field programmable gate array, a state machine, an integrated circuit and the like, and the hardware device operates to perform the processes shown in FIG. 2A or 4 of the method.

As shown in FIG. 2B, the data collection and analysis apparatus 4 may include a power loss calculator component 61 that may perform the processes S101 in FIG. 2A or the processes S201 in FIG. 4, a cost of power loss generator component 62 that may perform the processes S102 in FIG. 2A or the processes S202 of FIG. 4, a total cost of power loss generator component 63 and a cleaning time determining component 64 that may perform the processes S103, S104 in FIG. 2A or S203, S204 in FIG. 4.

A solar cell module system 1 is shown in FIG. 5 that uses the cleaning apparatus 6 and the method according to the disclosure shown in FIGS. 2A and 4 for determining the time point to clean the solar cell module. The solar cell module system 1 generally has a reference module 2 which is a solar power generation module (solar cell module or solar cell or other solar generating module or device) whose surface always remains in a clean condition so that the power generation of a clean solar power generation module may be measured when the solar cell module system 1 resides in a particular environment. The solar cell module system 1 may also have an evaluation module 3 which is a solar power generation module whose surface, due to the particular environment in which the solar cell module system 1 resides, is covered by dust/dirt so that the power generation of a dirty solar power generation module in the particular environment may be measured when the solar cell module system 1 resides in the particular environment. The solar cell module system 1 may further have a typical solar module temperature sensor 7,8 coupled to each of the reference module 2 and the evaluation module 3.

The solar cell module system 1 also may comprise a data collecting and analysis element 4 that may have the components shown in FIG. 2B and may be configured to collect the data about the power generation of the evaluation module 3 and the reference module 2 and the power loss of the evaluation module 3 due to dust/dirt or other accumulation. The data collecting and analysis element 4 may also calculate the power generation loss, and do a calculation of a time point of cleaning and those methods are shown in FIGS. 2A and 4 and described below. The data collection and analysis element 4 may also receive data from a rain gauge 9 and a fine particle detector 10 as described below. The solar cell module system 1 also may comprise a display element 5 configured to display the time point of cleaning which is calculated by the data collecting element 4. The solar cell module system 1 also may comprise a known cleaning system 6 that actually performs the cleaning of the solar cell modules (and the evaluation module 3) at the time point of cleaning.

In addition to the reference module 2 and the evaluation module 3 as shown in FIG. 5, the solar cell module system 1 may have a plurality of power generating solar modules that are generating power. The plurality of power generating solar modules may be a large array of solar modules or any other configuration of solar modules since the solar cell module system 1 is not limited to any particular configuration of the plurality of solar modules coupled to the solar cell module system 1. In operation, the evaluation module 3 simulates the dust/dirt/other accumulation on each of the plurality of solar modules and thus also simulates the power loss for each of the plurality of solar modules during the normal operation of the solar cell module system 1. Thus, the solar cell module system 1 determines, during power generation of the solar module system 1 when the solar modules need to be cleaned as described below in more detail.

As shown in FIG. 2A, a method 20 for determining a time point to clean a solar cell module according to the first embodiment of the disclosure comprises one or more processes. The processes of the method 20 may be performed, in one embodiment by the data collection and analysis element 4 shown in FIGS. 2B and 5. In the method, a process may calculate a power generation loss of the solar cell module in a time period due to dust accumulation (S101) as described below in more detail. In some embodiments, this process may be performed by the data collection and analysis element 4 (or the power loss calculator component 61). The method may then convert the calculated power generation loss in the time period due to dust accumulation into a cost of power generation loss (S102) as described below in more detail. In some embodiments, this process may be performed by the data collection and analysis element 4 (or the cost of power loss generator component 62). The method may then calculate a total cost of power generation loss which is equal to a cost of cleaning through the cost of power generation loss in the time period (S103) as described below in more detail. In some embodiments, this process may be performed by the data collection and analysis element 4 (or the total cost of power loss generator component 63). The method may also determine the time point of cleaning from the total cost of power generation loss (S104) as described below in more detail. In some embodiments, this process may be performed by the data collection and analysis element 4 (or the cleaning time determining component 64).

As shown in FIG. 1 and FIG. 2A, the power generation loss of the solar cell module in a time period due to dust accumulation is determined (S101) in which a time period (from beginning point T1 to terminal point TX as shown in FIG. 1) is decided first and a plurality of samples are taken to obtain a plurality of sampled data points. Then, each power loss for each of the plurality of sampled data points in the time period is calculated by subtracting the generation power of the evaluation module 3 for each sampled data point from the generation power of the reference module 2 for each sampled data point. The generation power for each of these modules 2,3 may be determined using existing known technologies. Next, a linear relationship between the time and power loss for all the sampled data points is acquired and the power loss a3 within the time period could be calculated by using the straight line Sr1 between the power loss al at the beginning point T1 of the time period, and the power loss a2 at the terminal point TX of the time period as shown in FIG. 1.

In addition, the data of the above-mentioned sampled data points may be updated at predefined time point t by using the display element 5 to set that predefined time point t by the user. The predefined time point, t, to do the updating may be defined as a length of a time period, e.g. every day, every week or every month.

In order to determine whether the power generation loss for the surface of the evaluation module 3 (and hence the rest of the solar modules in the solar module system 1) is due to dust/dirt accumulation or another factor (such as the system 1 operating in an abnormal manner due to something other than dust/dirt accumulation), the rain gauge 9 and the fine particle detector 10 may be further used for assisting that determination by the data collection and analysis element 4. In general, when the amount of fine particle detected by the fine particle detector 10 is larger, the power loss due to dust accumulation will increase. On the other hand, when the amount of rainfall detected by the rain gauge is larger, the surface of the solar generation module will be washed and become cleaner, so that the power loss due to dust accumulation would reduce. If not the cases stated above, the cause of power loss could be inferred as being different from dust accumulation. Therefore, it will be determined whether the system 1 or detecting elements, such as rain gauge 9 or fine particle detector 10, needs to be inspected.

When the solar power generation power module 3 is covered by dust or dirt, its efficiency in receiving thermal energy will be affected. Therefore, respective thermal sensors 7, 8 of the reference module 2 and the evaluation module 3 may be disposed to obtain the temperature difference between the reference module 2 and the evaluation module 3 to assist the determination if the power loss situation is due to dust accumulation.

Returning to FIG. 2A, the method converts the calculated power generation loss in the time period due to dust accumulation into a cost of power generation loss (S102). More specifically, the calculated power generation loss a3 in the time period is converted into a loss cost L of the power generation loss a3 based on the unit power generation cost. For example, if the cost per kilowatt (kW) is NT$ 5 and the loss power in one day is 200 kW, the cost of the loss power will be NT$ 1,000 (5*200=1,000).

The method may then calculate a total cost of power generation loss which is equal to a cost of cleaning through the cost of power generation loss in the time period (S103). More specifically, the straight line Sr1 (shown in FIG. 1 derived at S101) in relation to time and lost power in the time period and the cost L of power generation loss in the time period is used to calculate the total cost L1 of power generation loss for the total power generation loss aₜₒₜₐₗ, which is equal to the cost of cleaning.

Finally, the total cost L1 of power generation loss calculated (S103), and the straight line Sr1 in relation to time and power loss, which is calculated in S101, are introduced into the following equation (1) to determine the time point Fct to clean the solar cell module (S104):

F_{ct}=\sqrt{2L1/Sr1} Equation (1)

where

Fct: time point of cleaning;

L1: total cost of power generation loss; and

Sr1: straight line in relation to time and power loss.

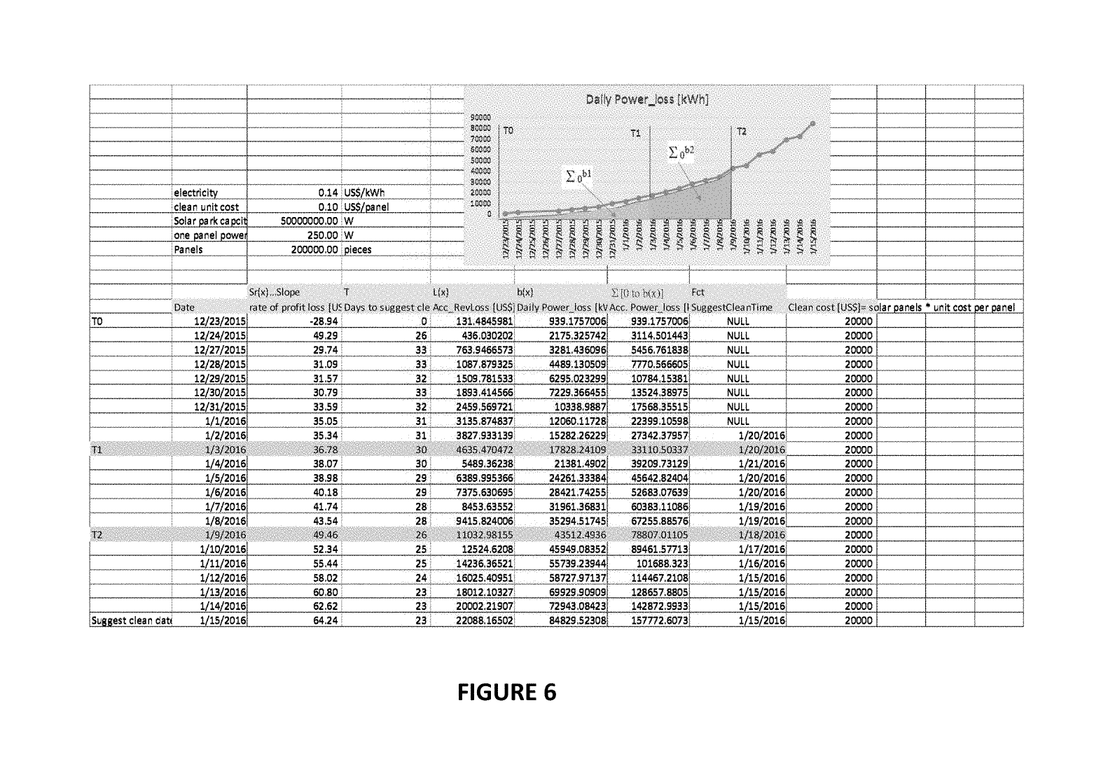

An example of the application of the above equation to solar cell data is shown in FIG. 6.

The method for determining the time point to clean the solar cell module according to the first embodiment may further comprise a cleaning process that is not shown in FIG. 2A.

Specifically, when the total cost L1 of the power generation loss is equal to the cost C of cleaning, the cleaning is performed. The cost of cleaning may depend on local currency, the method adopted to clean the solar module, such as human labor, robot, any vehicle to use, water available, and so on.

In order to perform this process, the solar cell module system 1 may thus further have the cleaning system 6. The cleaning system 6, for example, may be a cleaning device (not shown); a cleaning control element (not shown) configured to decide a cleaning area, procedure, and cleaning manner of the cleaning device so as to clean the solar cell module; and an action confirming element (not shown) which confirms the cleaning action via an image, a switching signal from the cleaning device or a value shown by the DC meter. The cleaning device may be disposed on the evaluation module 3 and may be any kind of physical cleaning device, such as spraying device, gas purge device, mechanical brushing head or scraper.

In addition, the method according to the first embodiment for determining the time point to clean a solar cell module is not so limited to the above-described sampling manner for the solar cell module. For example, the time point of cleaning may also be determined based on the historical information about the power loss of the solar cell module due to average amount of sunshine in local and average dust accumulation.

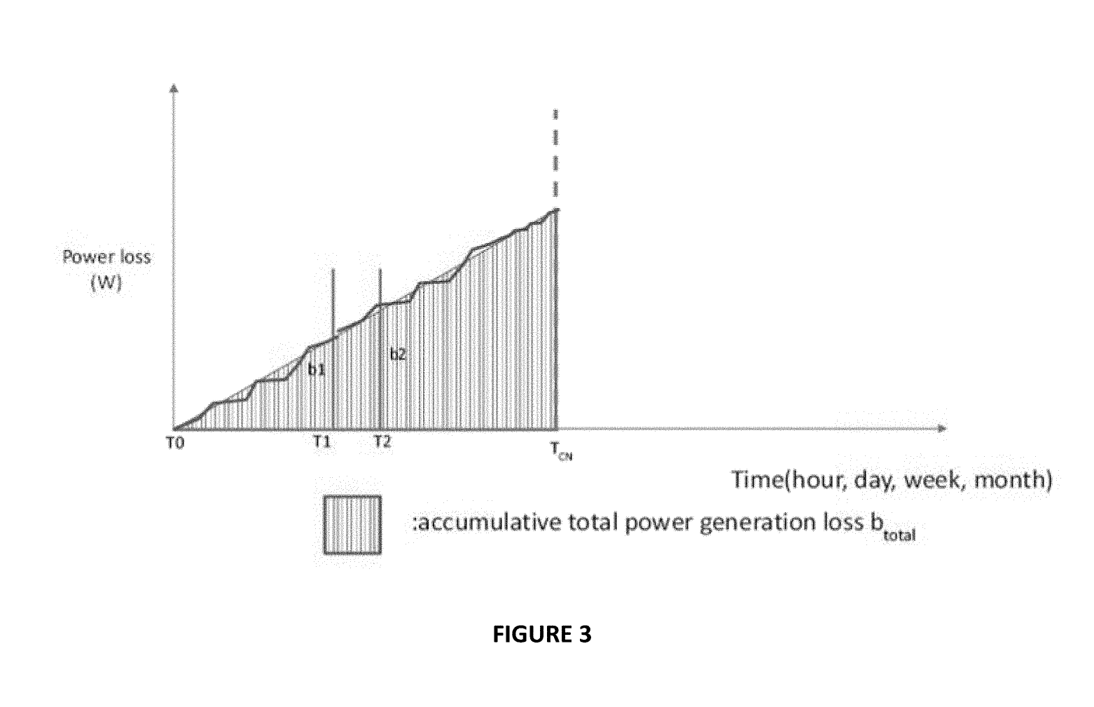

Further, the method according to a second embodiment for determining the cleaning point of cleaning a solar cell module will be described below with reference to FIG. 3 and FIG. 4. FIG. 3 is a diagram illustrating the calculation method according to the second embodiment for determining the time point to clean a solar cell module. The horizontal axis of FIG. 3 represents time and the vertical axis of FIG. 3 represents power loss. FIG. 4 is a flowchart showing the method according the second embodiment for determining the time point to clean the solar cell module. The solar cell module system 1 using the method according to the second embodiment for determining the time point to clean the solar cell module is identical to that used in the first embodiment described above and thus the description of such solar cell module system is omitted herein.

Referring to FIG. 4, the method according to the second embodiment for determining the time point to clean a solar cell module calculates an accumulative power generation loss of the solar cell module due to dust accumulation (S201). The method may also convert the calculated accumulative power generation loss due to dust accumulation into a cost of the power generation loss (S202) and instantaneously compare the cost of the power generation loss with a cost of cleaning (S203). If the cost of the power generation loss is less than the cost of cleaning, the method will be back to S201 of calculating the accumulative power generation loss of the solar cell module due to dust accumulation. If the cost of the power generation loss is equal to or greater than the cost of cleaning, the method will proceed to generate a notification of cleaning (S204).

As shown in FIG. 3, from the beginning time point (T0) where no power loss occurs, the power generation loss of each sampled data point is calculated (S201) when taking each sample and then summing up the power generation losses of these sampled data points as the total power generation loss bₜₒₜₐₗ. For example, at the sampled data point T1 obtaining its power generation loss b1, the total power generation power loss bₜₒₜₐₗ at the sampled data point T1 is Σ₀^{b1}. At the sampled data point T2 obtaining its power generation loss b2, the total power generation power loss bₜₒₜₐₗ at the sampled data point T2 is Σ₀^{b2}. The total power generation loss bₜₒₜₐₗ summed up in S201 is converted into a loss cost L2 based on the unit power generation cost (S202). The conversion technique may be the same as described above with reference to FIG. 2A.

Next, the total loss cost L2 of power generation loss is compared with a cost L of cleaning (S203). If the total loss cost L2 of power generation loss is less than the cost C of cleaning, the method will be back to S201 and again summing up the power generation loss of the sampled data points as the total power generation loss bₜₒₜₐₗ which is converted into a loss cost L2. If the total loss cost L2 of power generation loss is equal to or greater than the cost C of cleaning, the cleaning notification process (S204) may be performed. Thus, since the cost L2 of power generation loss is equal to the cost C of cleaning, the cleaning notification is made at the time point T_{CN}. An example of this calculation is shown in FIG. 6.

As with the method according to the first embodiment for determining the time point to clean a solar cell module, the method according to the second embodiment for determining the time point to clean a solar cell module can also further comprise a cleaning process. The cleaning process may be also the same as that in the first embodiment so that the detailed description thereof is omitted herein.

In addition to the reference module 2, evaluation module 3, data collecting element 4, display element 5, cleaning system 6, temperature sensors 7, 8, rain gauge 9 and fine particle detector 10, the solar cell module system 1 may even have a solar cell module efficacy monitoring system or solar power generation monitoring system disclosed in the present applicant's TW patent publications Nos. TW 201350892 and TW 201414134. Furthermore, in addition to the structure disclosed by the aforesaid two patent applications, any other auxiliary element for assisting the power generation efficacy or monitoring efficacy of the solar cell module system 1 may also be added without departing from the spirit of the method according to the present invention for determining the time point to clean a solar cell module, i.e. when the total cost of power generation loss is equal to the cost of cleaning, it will be the most preferable time point to clean a solar cell module with economic benefits.

The method for determining the time point to clean a solar cell module and the solar cell module system using said method according to the present invention have been described above. However, the present invention is not so limited to this, and numerous variations of the present invention are possible within the scope of the appended claims. For example, once obtaining the total cost of power generation loss equal to the cost of cleaning, the time point of cleaning can be acquired in any manner. According to the method of the present invention for determining the time point to clean a solar cell module and the solar cell module system using said method, the power loss of the solar cell module due to dust accumulation can be effectively avoided with economic benefits.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chosen and described in order to best explain the principles of the disclosure and its practical applications, to thereby enable others skilled in the art to best utilize the disclosure and various embodiments with various modifications as are suited to the particular use contemplated.

The system and method disclosed herein may be implemented via one or more components, systems, servers, appliances, other subcomponents, or distributed between such elements. When implemented as a system, such systems may include an/or involve, inter alia, components such as software modules, general-purpose CPU, RAM, etc. found in general-purpose computers. In implementations where the innovations reside on a server, such a server may include or involve components such as CPU, RAM, etc., such as those found in general-purpose computers.

Additionally, the system and method herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the system and method may be achieved via or performed by logic and/or logic instructions including program modules, executed in association with such components or circuitry, for example. In general, program modules may include routines, programs, objects, components, data structures, etc. that perform particular tasks or implement particular instructions herein. The inventions may also be practiced in the context of distributed software, computer, or circuit settings where circuitry is connected via communication buses, circuitry or links. In distributed settings, control/instructions may occur from both local and remote computer storage media including memory storage devices.

The software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules and/or other components. Further, communication media may include wired media such as a wired network or direct-wired connection, however no media of any such type herein includes transitory media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. Finally, the modules can be implemented using special purpose instructions (SIMD instructions), field programmable logic arrays or any mix thereof which provides the desired level performance and cost.

As disclosed herein, features consistent with the disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) though again does not include transitory media. Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the invention have been specifically described herein, it will be apparent to those skilled in the art to which the invention pertains that variations and modifications of the various implementations shown and described herein may be made without departing from the spirit and scope of the invention. Accordingly, it is intended that the invention be limited only to the extent required by the applicable rules of law.

While the foregoing has been with reference to a particular embodiment of the disclosure, it will be appreciated by those skilled in the art that changes in this embodiment may be made without departing from the principles and spirit of the disclosure, the scope of which is defined by the appended claims.

1. A method for determining a time point to clean a solar cell module, the method comprising:
calculating a power generation loss of the solar cell module in a time period due to material accumulation that affects the power generation efficiency of the solar cell module;
converting the calculated power generation loss in the time period into a cost of the power generation loss;
calculating a total cost of the power generation loss when it is equal to a cost of cleaning through the cost of the power generation loss in the time period; and
determining a time point of cleaning based on the total cost of the power generation loss.

2. The method of claim 1, wherein calculating the power generation loss in a time period further comprises deciding the time period and sampling in the time period to obtain a plurality of data points; and wherein the power generation loss in the time period is calculated by obtaining a straight line in relation to the time points and power loss for all sampled data points in the time period and then using the straight line and power losses at the beginning and terminal sampled data points in the time period.

3. The method of claim 1, wherein determining the time point further comprises determining the time point, Fct, using the equation:
F_{ct}=\sqrt{2L1/Sr1}\sqrt{2L1/Sr/1}
Fct represents the time point of cleaning;
L1 represents the total cost of power generation loss; and
Sr1 represents the linear relationship.

4. The method of claim 1, wherein the material accumulation is one of dust accumulation and dirt accumulation.

5. The method of claim 1, wherein converting the calculated power generation loss further comprises converting the power generation loss into a cost of the power generation loss is based on the unit cost of power generation.

6. The method of claim 1 further comprising cleaning the solar module when the total cost of power generation loss is equal to the cost of cleaning.

7. A method for determining a time point to clean a solar cell module, the method comprising:
calculating an accumulative power generation loss of the solar cell module due to a material accumulation;
converting the calculated accumulative power generation loss into a cost of the power generation loss;
instantaneously comparing the cost of the power generation loss with a cost of cleaning; and
generating a cleaning notification when the cost of the power generation loss is greater than the cost of cleaning.

8. The method of claim 7 further comprising recalculating an accumulative power generation loss of the solar cell module due to a material accumulation when the cost of the power generation loss is less than the cost of cleaning.

9. The method of claim 7, wherein calculating an accumulative power generation loss of the solar cell module begins where no power generation loss occurs, calculates the power generation loss when taking each sampled data point, and sums up the power generation losses for all sampled data points as a total power generation loss.

10. The method of claim 7, wherein converting the calculated power generation loss further comprises converting the power generation loss into a cost of the power generation loss is based on the unit cost of power generation.

11. The method of claim 7 further comprising cleaning the solar module when the total cost of power generation loss is equal to the cost of cleaning.

12. The method of claim 7, wherein the material accumulation is one of dust accumulation and dirt accumulation.

13. A solar cell module system, comprising:
a reference module comprising a solar power generation module having a surface maintained in a clean condition;
an evaluation module comprising a solar power generation module having a surface being covered by material accumulation in an environment; and
a data collecting element configured to collect the data of power generation loss of the evaluation module due to material accumulation, calculate the power generation loss, and determine a calculation of a time point of cleaning.

14. The system of claim 13 further comprising a display element configured to display the time point of cleaning calculated by the data collecting element.

15. The system of claim 13, wherein the data collecting element calculates the power generation loss by deciding the time period and sampling in the time period to obtain a plurality of data points; and wherein the power generation loss in the time period is calculated by obtaining a straight line in relation to the time points and power loss for all sampled data points in the time period and then using the straight line and power losses at the beginning and terminal sampled data points in the time period.

16. The system of claim 13, wherein determining the time point further comprises determining the time point, Fct, using the equation:
F_{ct}=\sqrt{2L1/Sr1}\sqrt{2L1/Sr/1}
Fct represents the time point of cleaning;
L1 represents the total cost of power generation loss; and
Sr1 represents the linear relationship.

17. The system of claim 13, wherein the material accumulation is one of dust accumulation and dirt accumulation.

18. The system of claim 13, wherein the data collecting element converts the calculated power generation loss into a cost of the power generation loss is based on the unit cost of power generation.

19. The system of claim 13 further comprising cleaning the solar module when the total cost of power generation loss is equal to the cost of cleaning.

20. The system of claim 13 further comprising a rain gauge configured to assist the determination of the power generation loss due to material accumulation.

21. The system of claim 13 further comprising a fine particle detector configured to assist the determination of the power generation loss due to dust accumulation.

22. The system of claim 13 further comprising a cleaning system configured to perform the cleaning when the total power generation loss is equal to the cost of cleaning.

23. The system of claim 22, wherein the cleaning system at least comprises:
a cleaning device selected from one of a spraying device, gas purge device, mechanical brushing head and scraper; and
a cleaning control element configured to decide a cleaning area, procedure, cleaning manner for the cleaning device to perform the cleaning of the solar cell module.

24. An apparatus for determining a cleaning time, comprising:
a processor that executes a plurality of lines of computer code, the processor being configured to:
calculate a power generation loss of the solar cell module in a time period due to material accumulation that affects the power generation efficiency of the solar cell module;
convert the calculated power generation loss in the time period into a cost of the power generation loss;
calculate a total cost of the power generation loss when it is equal to a cost of cleaning through the cost of the power generation loss in the time period; and
determine a time point of cleaning based on the total cost of the power generation loss.

25. The apparatus of claim 24, wherein the processor is further configured to decide the time period and sample in the time period to obtain a plurality of data points; obtain a straight line in relation to the time points and power loss for all sampled data points in the time period and then using the straight line and power losses at the beginning and terminal sampled data points in the time period.

26. The apparatus of claim 24, wherein the processor is further configured to determine the time point, Fct, using the equation:
F_{ct}=\sqrt{2L1/Sr1}\sqrt{2L1/Sr/1}
Fct represents the time point of cleaning;
L1 represents the total cost of power generation loss; and
Sr1 represents the linear relationship.

27. The apparatus of claim 24, wherein the material accumulation is one of dust accumulation and dirt accumulation.

28. The apparatus of claim 24, wherein the processor is further configured to convert the power generation loss into a cost of the power generation loss is based on the unit cost of power generation.
